(19) United States
(12) Patent Application Publication
(10) Pub. No.: US 2004/0104681 A1
(43) Pub. Date: Jun. 3, 2004

(54) Plasma processing system and method

(75) Inventor: Andrej S. Mitrovic, Phoenix, AZ (US)

Correspondence Address: PILLSBURY WINTHROP, LLP, P.O. BOX 10500, MCLEAN, VA, 22102, US

(73) Assignee: Tokyo Electron Limited, Tokyo (JP)

(21) Appl. No.: 10/720,059

(22) Filed: Nov. 25, 2003

Related U.S. Application Data
(60) Provisional application No. 60/429,067, filed on Nov. 26, 2002.

(51) Int. Cl. H01J 7/24

(52) U.S. Cl. 315/111.21; 315/111.41

(57) ABSTRACT

A plasma processing system includes a magnetic field generator that can produce a magnetic field and a sheet optic element that can produce a light sheet capable of illuminating particles in a processing chamber of the system. An imaging device can acquire image data corresponding to the particles illuminated by the light sheet. The magnetic field generator, the sheet optic element and the imaging device can be positioned relative to one another to access the plasma. An image processor can process the image data so as to obtain the concentration of particles in the light sheet. A method of measuring particle concentration in a plasma processing system includes positioning the magnetic field generator, a sheet optic element and an imaging device relative to one another to access the plasma and obtaining the concentration of particles in the light sheet. A method of minimizing particles in the chamber is also provided.

This non-provisional application claims the benefit of U.S. Provisional Application No. 60/429,067, which was filed on Nov. 26, 2002, the contents of which are incorporated herein by reference.

### BACKGROUND OF THE INVENTION

1. Field of Invention

The present invention relates to plasma processing and more particularly to measuring particle concentration in a plasma processing system.

2. Description of Background Information

Typically, plasma is a collection of species, some of which are gaseous and some of which are charged. Plasmas are useful in certain processing systems for a wide variety of applications. For example, plasma processing systems are of considerable use in material processing and in the manufacture and processing of semiconductors, integrated circuits, displays and other electronic devices, both for etching and layer deposition on substrates, such as, for example, semiconductor wafers.

In most plasma processing systems, solid particles, e.g., bellows, valves, or wall deposits flaking off, can be present in the plasma. During wafer processing, such particles, which range in size from sub-micron size to sizes greater than a few millimeters, can be deposited on the wafer surface where devices are being made, thereby causing damage to devices and reducing yield. Many process parameters affect generation of such particles. For example, RF and DC biases can “float” particles near the wafer and the plasma chemistry can have a greater or lesser tendency of creating wall deposits that may flake off.

One consideration for selecting the process recipe when manufacturing a device is maintaining a low concentration of such particles, at least in the vicinity of the wafer. A system and method of measuring the concentration of particles in the chamber could help select a process recipe for a device manufacturing process that maintains a low concentration of particles.

### SUMMARY OF THE INVENTION

One aspect of the invention is to provide a plasma processing system in communication with a plasma diagnostic system. The plasma processing system comprises a chamber containing a plasma processing region and a chuck constructed and arranged to support a substrate within the chamber in the processing region. The plasma processing system further comprises a magnetic field generator configured to produce a magnetic field and a sheet optic element configured to produce a light sheet capable of illuminating particles in a processing chamber. An imaging device is configured to acquire image data corresponding to the particles while the particles are illuminated by the light sheet. The magnetic field generator, the sheet optic element and the imaging device are positioned relative to one another to access the plasma. An image processor is configured to process the image data so as to obtain a concentration of particles in the light sheet.

Another aspect of the invention is to provide a method of measuring particle concentration in a plasma processing system having a chamber containing a plasma processing region in which a plasma can be generated during a plasma process and a magnetic field generator configured to produce a magnetic field in the chamber. The method comprises positioning the magnetic field generator, a sheet optic element and an imaging device relative to one another to access the plasma. Particles are illuminated in the chamber with the sheet optic element and image data corresponding to the particles illuminated by the light sheet is acquired with the sheet optic element. The method further comprises obtaining a concentration of particles in the light sheet, e.g., as a function of location of the particles in the chamber.

### BRIEF DESCRIPTION OF THE DRAWINGS

The accompanying drawings, which are incorporated in and constitute a part of the specification, of embodiments of the invention, together with the general description given above and the detailed description of the embodiments given below, serve to explain the principles of the invention wherein:

FIG. 1 is a diagrammatic cross section of an embodiment of a plasma processing system in accordance with principles of the invention;

FIG. 2 is a perspective view of the measurement system shown in FIG. 1;

FIG. 3 is a schematic view of one example of a sheet optic element that can be used in the measurement system shown in FIG. 1;

FIG. 4 is a schematic view of an alternative embodiment of the measurement system;

FIG. 5 is a schematic view of another alternative embodiment of the measurement system;

FIG. 6 is a schematic view of one example of a sheet optic element that can be used in the measurement system shown in FIG. 5;

FIG. 7 is a diagrammatic cross section of another embodiment of the measurement system shown associated with a portion of plasma processing chamber;

FIG. 8 is a diagrammatic cross section of another embodiment of the measurement system shown associated with a portion of plasma processing chamber;

FIG. 9 is a flow chart showing a method of measuring particle concentration in a plasma processing system in accordance with principles of the invention; and

FIG. 10 is a flow chart showing a method of minimizing particle concentration in a plasma processing system in accordance with principles of the invention.

### DETAILED DESCRIPTION OF EMBODIMENTS

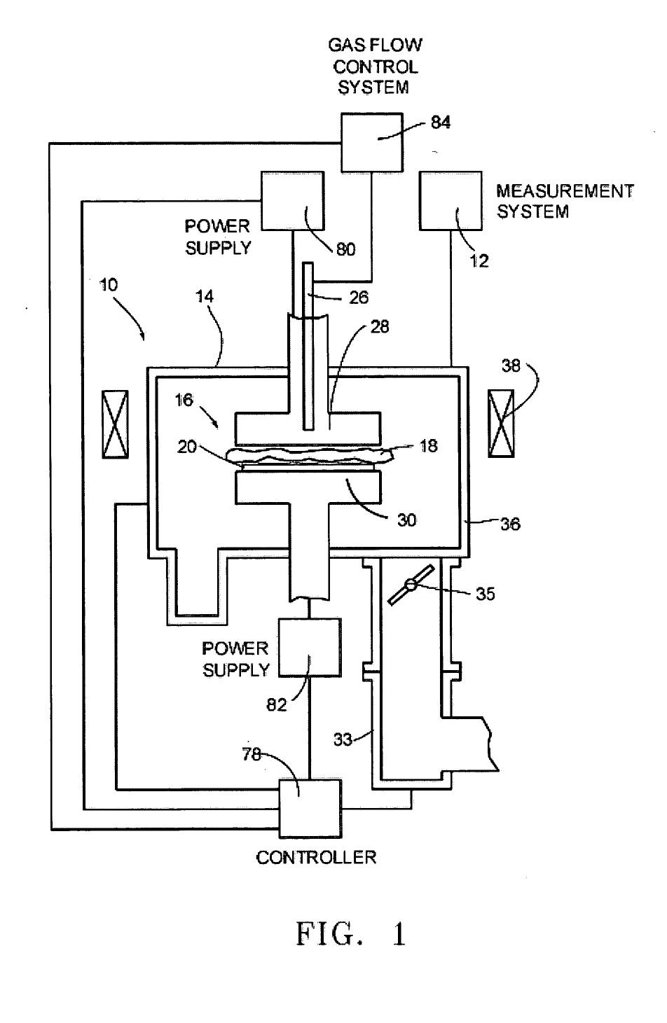

FIG. 1 shows an embodiment of a plasma processing system according to principles of the invention. The plasma processing system, generally indicated at 10, is in communication with a measurement system 12 and a magnetic field generator 38, which are both schematically shown in FIG. 1. The measurement system 12 is configured to measure particle concentration in a plasma processing system 10, as will be described in greater detail below.

The plasma processing system 10 comprises a plasma process chamber, generally indicated at 14, that defines a plasma processing region 16 in which a plasma 18 can be generated. A chuck or electrode 30 can be positioned in the chamber 14 and is constructed and arranged to support a substrate 20, which may be a semiconductor wafer, for example, within the chamber 14 in the processing region 16. The substrate 20 can be a semiconductor wafer, integrated circuit, a sheet of a polymer material to be coated, a metal to be surface hardened by ion implantation, or some other semiconductor material to be etched or deposited, for example.

Although not shown, coolant can be supplied to the chuck 30, for example, through cooling supply passages coupled to the chamber 14. Each cooling supply passage can be coupled to a cooling supply source. For example, the cooling supply passages can be individually connected to the cooling supply source. Alternatively, cooling supply passages can be interconnected by a network of interconnecting passages, which connect all cooling supply passages in some pattern.

Generally, plasma generation gas, which can be any gas that is ionizable to produce a plasma, is introduced into the chamber 14 to be made into a plasma, for example, through a gas inlet 26. The plasma generation gas can be selected according to the desired application as understood by one skilled in the art and can be nitrogen, xenon, argon, carbon tetrafluoride (CF₄) or octafluorocyclobutane (C₄F₈) for fluorocarbon chemistries, chlorine (Cl₂), hydrogen bromide (HBr), or oxygen (O₂), for example.

The gas inlet 26 is coupled to the chamber 14 and is configured to introduce plasma processing gases into the plasma processing region 16. A plasma generator in the form of upper electrode 28 and lower electrode (or chuck) 30 may be coupled to the chamber 14 to generate the plasma 18 within the plasma processing region 16 by ionizing the plasma processing gases. The plasma processing gases can be ionized by supplying RF and/or DC power thereto, for example, with power supplies 80, 82 coupled to the upper electrode 28 and the lower electrode 30, respectively. In some applications, the plasma generator may be an antenna or RF coil capable of supplying RF power, for example.

A variety of gas inlets or injectors and various gas injecting operations can be used to introduce plasma processing gases into the plasma processing chamber 14, which can be hermetically sealed and can be formed from aluminum or another suitable material. The plasma processing gases are often introduced from gas injectors or inlets located adjacent to or opposite from the substrate. For example, as shown in FIG. 1, gases supplied through the gas inlet 26 can be injected through an inject electrode (upper electrode 28) opposite the substrate in a capacitively coupled plasma (CCP) source. The gases supplied through the gas inlet 26 can be controlled with a gas flow control system 84. The power supplied to the plasma, by power supplies 80, 82, for example, can ignite a discharge with the plasma generation gas introduced into the chamber 14, thus generating a plasma, such as plasma 18.

Alternatively, in embodiments not shown, the gases can be injected through a dielectric window opposite the substrate in a transformer coupled plasma (TCP) source or through a gas inject plate in an inductively coupled plasma (ICP) source. Other gas injector arrangements are known to those skilled in the art and can be employed in conjunction with the plasma processing chamber 14 as well as other plasma sources, such as Helicon and electron cyclotron resonance sources, for example.

The plasma process chamber 14 is fitted with an outlet having a vacuum pump 33 and a valve 35, such as a throttle control valve, to provide gas pressure control in the plasma process chamber 14.

Various leads (not shown), for example, voltage probes or other sensors, can be coupled to the plasma processing system 10.

A controller 78 capable of generating control voltages sufficient to communicate and activate inputs to plasma processing system 10 as well as capable of monitoring outputs from the plasma processing system 10 can be coupled to the plasma processing system 14. For example, the controller 78 can be coupled to and can exchange information with the RF power supplies 80, 82 of the upper electrode 28 and the lower electrode 30, respectively, and the gas flow control system 84 in fluid communication with gas inlet 26. The controller 78 can further be in communication with the pumping system 33 and gate valve 35, respectively, although not shown in FIG. 1. A program, which can be stored in a memory, may be utilized to control the aforementioned components of plasma processing system 10 according to a stored process recipe. Alternatively, multiple controllers 78 can be provided, each of which being configured to control different components of the plasma processing system 10, for example. One example of the controller 78 is an embeddable PC computer type PC/104 from Micro/SYS of Glendale, Calif.

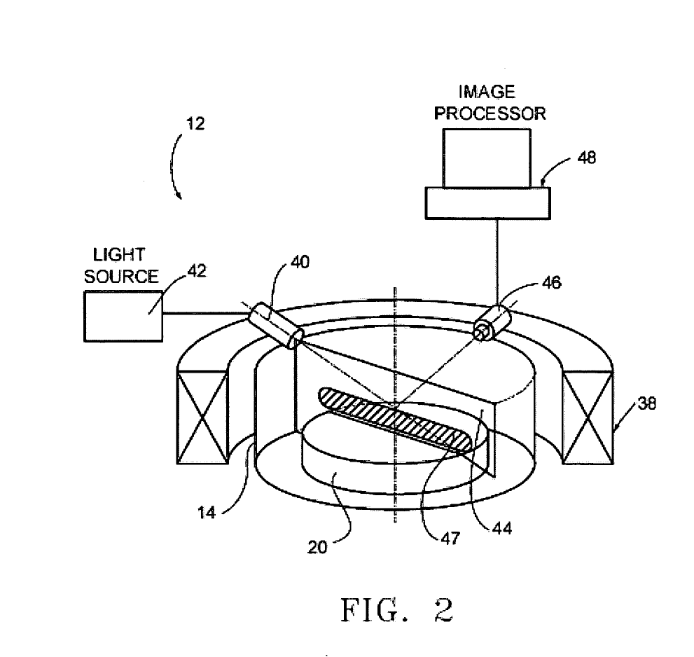

The magnetic field generator, generally indicated at 38 in FIGS. 1 and 2 and briefly mentioned above, is positioned external to the chamber 14 in substantially surrounding relation therewith. The magnetic field generator 38 can have a substantially annular or torroidal configuration, which is rotatable to produce a magnetic field in the plasma process region 16, e.g., to increase plasma uniformity. The magnetic field generator 38 can include an electromagnet, a current carrying coil, permanent magnets, or any other device capable of producing a magnetic field in the plasma process region 16 of the chamber 14. The magnetic field generator 38 generates a rotating magnetic field. This can be accomplished electronically with electromagnets or by rotating the magnetic field generator.

FIG. 2 shows the measurement system 12 in greater detail. The optical system 12 includes a sheet optic element 40 fixedly positioned in communication with the chamber 18 and a light source 42. The light source 42 may include a laser or any other light source, e.g., a white light source with optional colored filters. The sheet optic element 40 can be a lens system including at least one of a cylindrical lens, a mirror and a prism. However, other optical elements may be used as well.

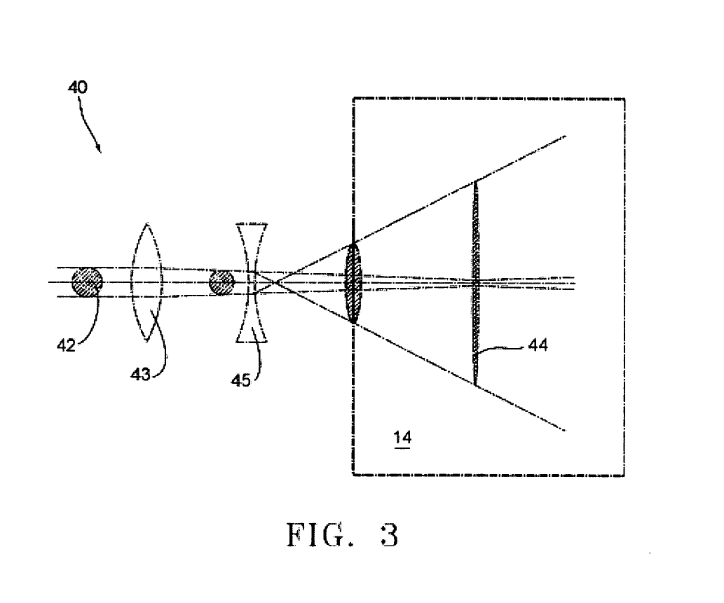

The sheet optic element 40 is spaced from the magnetic field generator 38 and configured to receive light emitted from the light source 42 to produce a light sheet 44 including an optical axis thereof (as shown by a dotted line in FIG. 2). FIG. 3 shows one example of the sheet optic element 40 receiving light emitted from the light source 42. In this example, the sheet optic element 40 includes a spherical lens 43 and a cylindrical lens 45, but as described above can also include a mirror or a prism, for example. The spherical lens 43, which can be either a convex or plano-convex spherical lens, has a focal length that brings the light emitted from the light source 42 into focus at about the center of the chamber 14. For example, the spherical lens 43 can have a focal length equal to about half of the diameter of the chamber 14.

The converging beam from the spherical lens 43 is passed through the cylindrical lens 45, which can be a concave cylindrical lens or other type of cylindrical lens, to focus the light beam in one plane. For example, the cylindrical lens 45 can have a focal point which is close to the sheet optic element 40 to accomplish the focusing. The initially round-sectioned beam will pass through the cylindrical lens 45 to be focused and expanded into an elongated beam having an elliptical cross section that illuminates particles in the chamber. The terms “laser sheet” and “light sheet” include the elongated and thin elliptical beam of light used to illuminate particles in the chamber 14. As such, the light sheet 44 is capable of illuminating particles in the chamber 14, located within the plane of the light sheet 44.

Although the light sheet 44, as shown in FIGS. 2 and 3, is represented as a vertically extending plane formed in the chamber 14, the light sheet 44 can be positioned in other positions, e.g., horizontally or angled at some angle between horizontal and vertical as well.

An imaging device 46 is positioned in communication with the sheet optic element 40 and is configured to acquire image data corresponding to the illuminated particles through a window in the chamber. The imaging device 46 is positioned at an angle with respect to the light sheet 44 and can be mounted above the magnetic field generator 38 to image the light sheet 44. Area 47 represents the area of the image that contains illuminated particles.

The imaging device 46 can be, for example, an analog or CCD (e.g., monochrome or color) camera or a video camera having a sufficiently high frame rate, coupled to the plasma processing chamber 14 for conversion of image data to a digital representation, e.g., a pixel representation, of particles in the plasma processing chamber 14.

The imaging device 46 and the sheet optic element 40 can be mounted within the chamber 14, for example, to a side wall or an upper wall thereof. The imaging device 46 and the sheet optic element 40 can be spaced from one another at an angle, for example, 0° to 180° apart, around the chamber 14. The imaging device 46 and the sheet optic element 40 can be spaced at almost any angle because image de-projection with an image processor, such as the image processor described in greater detail below, can be used to compensate for the angle between the imaging device 46 and the sheet optic element 40.

The measurement system 12 includes an image processor 48 in communication with the imaging device 46 for processing the acquired image data. The image processor 48 may be a specialized image processing computer and such processing may be performed by a single platform or by a distributed processing platform. In addition, such processing and functionality can be implemented in the form of a special purpose hardware or in the form of software being run by a general purpose computer, such as a tool control computer, or any combination of both. Any image data handled in such processing or created as a result of such processing can be stored in any memory. By way of example, such image data may be stored in a temporary memory, such as in the RAM of a given computer system or subsystem. In addition, or in the alternative, such image data may be stored in longer-term storage devices, for example, magnetic disks, rewritable optical disks or other storage devices. For example, a computer-readable media may comprise any form of data storage mechanism, including such existing memory technologies as well as hardware or circuit representations of such structures and of such data.

The image processor 48 can include a framegrabber system to capture an image of illuminated particles in the chamber 14 as a function of location. The captured image can then be de-projected to obtain particle concentrations as a function of location within the light sheet 44, and chamber 14. The intensity of light in the acquired and de-projected image is under most conditions proportional to the local concentration of particles, which forms the basis of measuring particle concentrations.

For example, the framegrabber system can be a card inserted into a general purpose computer slot. An example of a framegrabber system having this configuration is made by Data Translation of Marlboro, Mass., for example, model DT3162 for monochrome, and model DT3153 for color image acquisition. Other models, either color or monochrome, could be used depending on the type of imaging device used.

Framegrabber systems can include an imaging input, such as a video input, to which the imaging device 46 can be connected via a cable, for example. The framegrabber system can digitize input received from the imaging device 46 into “grabbed” digital images of various digital file formats, such as TIF, BMP, JPEG, GIF, various framegrabber native formats, etc. The “grabbed” digital images can be further processed to extract particle information, e.g., local concentration of particles. Such digital images generally show the intensity of captured light in the image as being proportional to the local concentration of particles, e.g. more particles in a unit volume at some location equates to brighter pixels in the corresponding location in the image file.

Image de-projection can be performed on the “grabbed” digital images to discern the actual location of the imaged particles in the light sheet from the “grabbed” image. Typically, image de-projection is a software procedure or algorithm in which the “grabbed” image is taken along an optical axis of the imaging device in perspective view and not perpendicular to the light sheet, and is transformed into an “equivalent” image in which the image appears as if the imaging device had been mounted perpendicular with respect to the light sheet. Such de-projection algorithms are known in the art of digital image processing and are commonly referred to as digital image morphing, warping, transforming, etc. Examples of such digital image processing are described in the publication entitled, “Digital Image Warping”, which was written by G. Wolberg and published by Wiley-IEEE Press, 1^{st} ed., 1990, section 3.4.2.3. Perspective transformations: Quadrilateral-to-quadrilateral. Using the above described image de-projection, the area 47 shown in FIG. 2 can be made available in the transformed image and used to uniquely establish a correlation of pixel to spatial location within the light sheet.

It is not necessary to generate a “grabbed” image and an “equivalent” de-projected image, as described above. Alternatively, the mathematical transform for image de-projection can be applied directly to pixel locations in the “grabbed” image, to obtain actual spatial coordinates of the “grabbed” pixels, and thus the spatial location within the light sheet 44, and chamber 14.

The entire framegrabbing and de-projection process can be implemented in hardware on framegrabber systems equipped with graphical processor chips, or in systems with separate framegrabbers and hardware image processor boards. In such systems, the mathematical transformations can be performed at video-speed, in real time, e.g. at the speed at which the imaging device transmits image data to the framegrabber. An example of a suitable separate image processor board is the Data Translation DT385 1, equipped with a Texas Instruments TMS34020 graphic processor chip. This board could be used in conjunction with the framegrabber boards discussed above, for example.

The de-projected image of the particle concentrations can allow a manufacturing line operator to manually inspect the image data and monitor the plasma processing apparatus 10. Such measurements can be used to determine when, and if, the plasma processing system 10 or the plasma processing chamber 14 requires cleaning, for example. Thus, the plasma processing system 10 or the plasma processing chamber 14 can be cleaned only when necessary, which can improve typical yields, and increase time between preventive maintenance shutdowns, of the plasma processing system 10. It also allows the process engineer to adjust the process parameters so that particle generation is minimized, if that is necessary for some particularly sensitive process, e.g. the system provides the measurements that allow various process recipes to be compared.

The sheet optic element 40 can form the light sheet 44 in any manner, and can generate or simulate the light sheet 44 in any way. For example, the sheet optic element 40 can include a spinning or sweeping mirror or prism used to rapidly sweep-out the light beam into the light sheet 44. If the sweeping is done sufficiently faster than the frame-rate of the imaging device 46, an illusion of a stationary light sheet can be created, and images of entire particle distributions can be acquired at once. If the frame-rate is high and the sheet scan frequency is low, then the light beam can be illuminated only one line in each image, and multiple images may need to be acquired to measure the particle distribution within the sheet.

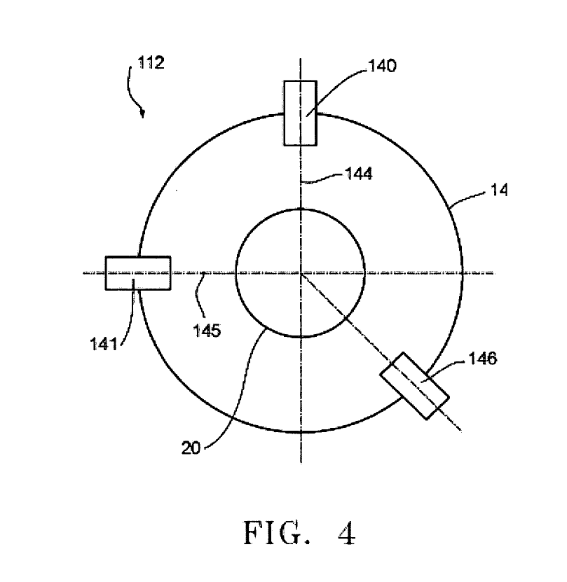

FIG. 4 shows a measuring system 112, which is an alternative embodiment of the measuring system 12. The measuring system 112 is configured to illuminate and image multiple sheets. For example, the measuring system 112 may include two or more sheet optic elements 140, 141 each configured to produce a respective light sheet 144, 145. In this illustrative example, the two light sheets 144, 145 are imaged by a single imaging device 146. The sheet optic elements 140, 141 and the imaging device 146 can be mounted above the magnetic field generator 38. In general, a plurality of imaging devices 46 or sheet optic elements 140, 141 can be used, and the light sheets 144, 145 can be positioned in many different positions, e.g., vertically, horizontally, or in some other position, within the chamber 14.

To image multiple sheets, such as sheets 144, 145, with the same image sensor, multiple different colors of light can be used to produce the light sheets. For example, lasers having different wavelengths or white light sources associated with color filters can be used to produce the multiple different colors of light, and hence the different colored light sheets. The imaging device 146, which can be a color video camera, for example, can be used to acquire images of the individual light sheets 144, 145. In other words, the image data can include one color component attributed to the light sheet 144 and another color component attributed to the light sheet 145. Particle concentrations and distributions within the light sheet images can then be separated by color.

For example, the intensities captured in sheets 144, 145 are separated by color using color separation techniques generally used in image processing and described above. If standard red, green and blue filters are used, one can directly read the red, green and blue intensity components of each pixel in the “grabbed” image, to obtain separate sheet images, which can then be further processed.

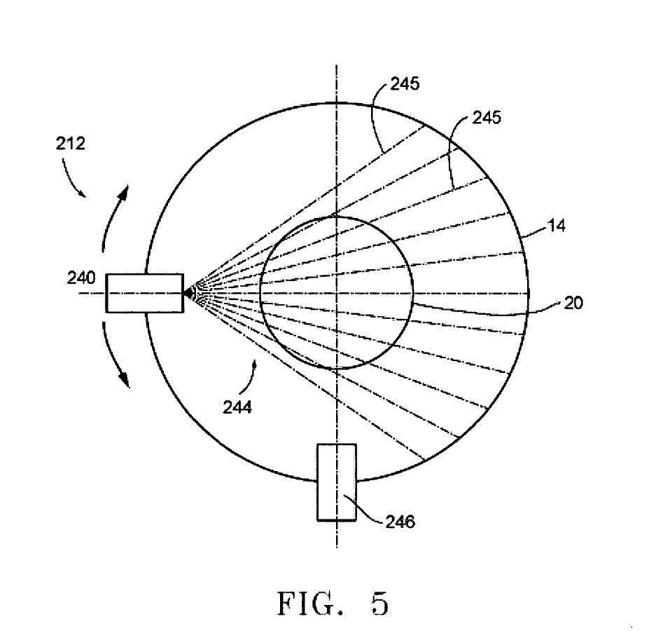

Both measurement systems 12, 112 shown in FIGS. 2 and 4 produce 2-dimensional distributions of particle concentration within the chamber 14. However, FIG. 5 shows a measurement system 212 capable of producing a three-dimensional particle concentration distribution within the chamber 14.

The measurement system 212 includes a sheet optic element 240 that generates a sheet that is swept in a generally arcuate direction relative to the chamber 14 by a drive mechanism (not shown), which may include a motor for driving a sheet optic element-carrying member for carrying the sheet optic element. Other drive mechanisms can be used as well.

The generally arcuate sweep of the sheet optic element 240 can produce the light sheet 244 in multiple positions (or at multiple angles) 245 within the chamber 14. In other words, the sheet optic element 240 can be moved by the drive mechanism to sweep-out a volume of the chamber 14 (limited by movement of the drive mechanism) within which concentrations of particles can be measured.

Although the measurement system 212 shows the drive mechanism limiting the generally arcuate movement of the sheet optic element 240 to a specific fan-like and sweeping movement range, the drive mechanism can also be configured to allow the sheet optic element 240, in particular its cylindrical lens, to rotate around its optical axis. This creates a rotating light sheet that rotates around the lens system optical axis. Such a rotating light sheet allows illumination of different planes in the chamber 14 at different angles, e.g. vertical, horizontal, and all angles in between.

By using synchronization, as described below in the form of an angular position feedback signal, and an appropriate sheet angle position feedback signal, de-projection of a particular image can be performed. For example, an angular position feedback line could transmit angular position feedback from the drive mechanism to the image processor and the image processor could then use the angular position feedback to de-project the image accordingly. This allows the entire three-dimensional particle concentration distribution in the volume swept by the rotating sheet 244 to be obtained, for example, by the image processor.

Alternatively, standard beam steering mirrors with voice-coil, electrostrictive, or piezoelectric actuators, for example, can be used in conjunction with a sheet optic element (e.g., sheet optic element 40 or sheet optic element 240) to “bounce” the light sheet that emerges from one of the sheet optic elements described above, to create the sweeping light sheet 244.

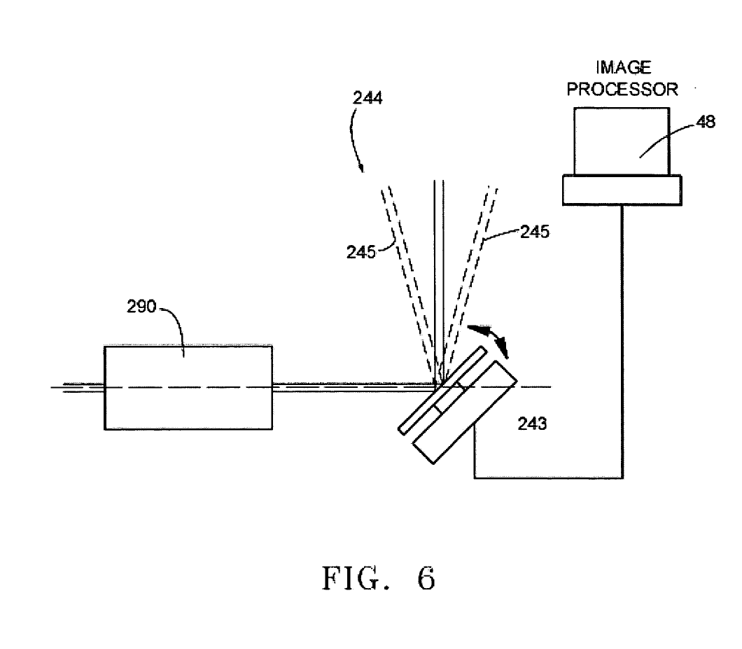

FIG. 6 shows a sheet optic element 290, which can have substantially similar structure as the sheet optic element 40 shown in FIGS. 2 and 3, used in conjunction with a scanning mirror 243 to produce the sweeping light sheet 244. The scanning mirror 243 can move relative to the sheet optic element 290 to form the sweeping light sheet 244. One such example of a beam scanning mirror system with an actuated mirror is manufactured by Newport Corp. of Irvine, Calif. and sold under the FSM series. Alternatively, a number of tip-tilt mirror actuation system models from Polytec PI, of Tustin, Calif. could be used as well.

An imaging device 246, which can be substantially similar in construction and operation as the imaging device 46 described above with respect to FIG. 2, can be fixedly mounted above the chamber 14 (or mounted above a magnetic field generator, for example). The imaging device 246 can be positioned generally transverse (at multiple angles) to the light sheet 244, as the light sheet 244 is rotated in the multiple positions. The imaging device 246 can be synchronized with the drive mechanism, so that an image processor, such as the image processor 48 described above with respect to FIG. 2, can compensate for the position of the light sheet 244 when de-projecting the captured images of the light sheet by the imaging device 246.

Synchronization can be performed using an angular position feedback signal, as shown routed between the scanning mirror 243 and the image processor 48 in FIG. 6. The feedback signal is proportional to the instantaneous mirror angular position, and thus the light sheet position can be fed into the image processor 48 for image processing. When the image processor 48 receives a new image, the image processor 48 will first read the instantaneous mirror, and light sheet angle, and then use that light sheet angle as input into a de-projection algorithm. Every different sheet position angle requires the same mathematical image transform to be used, but with a different set of input angle parameters, which are obtained through the feedback system. These input angles are angles, in all planes, of the instantaneous position of the light sheet with respect to the imaging device optical axis.

The angle that the sheet is away from a perpendicular position with respect to the imaging device axis (e.g. uppermost and lowermost sweep positions in FIG. 5 or rightmost and leftmost sweep positions in FIG. 6.) corresponds to the strength of image de-projecting or image warping that is needed, e.g., a large angle would require strong image de-projecting or image warping. With an imaging device 246 having a sufficiently high frame-rate and a sufficiently fast-swept light sheet 244, complete three-dimensional particle concentration distributions within the sheet swept-volume of the chamber 14 can be obtained by the image processor.

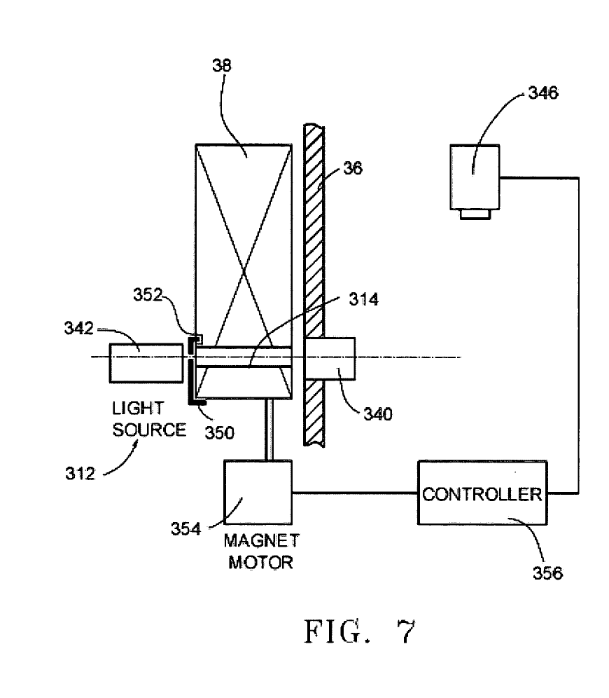

FIG. 7 shows a measurement system 312, which is an alternative embodiment of the measurement system 12. The measurement system 312 is configured to measure particle concentrations through one or more passageways 314 formed through the magnetic field generator 38.

The measurement system 312 includes a sheet optic element 340 mounted in the chamber wall 36 or external thereto for producing a light sheet 344 including an optical axis thereof (as shown by a dotted line in FIG. 7). FIG. 7 shows the sheet optic element 340 mounted to the chamber wall 36 inside the chamber 14. A light source 342 is configured to emit light to the sheet optic element 340 to produce a light sheet within the chamber 14. The light sheet would be intermittent (e.g. pulsed) as the passageway(s) 314 pass in front of the light feed system if the magnetic field generator 38 rotates.

If there is little or no space in the chamber 14, the sheet optic element 340 can be alternatively positioned external to the chamber 14 and the magnetic field generator 38. With the sheet optic element 340 positioned external to the chamber 14, the passageway(s) 314 formed through the magnetic field generator 38 can be formed as slits to allow unobstructed light sheets to enter the chamber 14.

A shield 350, e.g., a metal shield, can be provided between the light source 342 and the chamber wall 36 (or a window mounted in the chamber wall 36) to reduce light scattered from the magnetic field generator 38 at times when the light does not pass through the passageway(s) 314 (or, in other words, is obstructed). The shield 350 can be positioned so that a portion extends into one or more circumferential grooves 352 formed in the magnetic field generator 38. Substantially all light scattered from the magnetic field generator 38 (which does not pass through the passageway(s) 314) can be contained by the shield 350 so that the scattered light does not exit the measurement system 312. Electronic synchronization of an imaging device, e.g., a video camera, with the passing holes can be provided so that each image obtained by the imaging device can contain an image of the illuminated light sheet formed in the chamber 14.

FIG. 7 also shows a magnet motor 354 and a rotation speed controller 356, which cooperate to drive the magnetic field generator 38. A feedback signal on the instantaneous angular position of the magnetic field generator 38 is fed into an imaging device 346 from the controller 356 and is used to instruct the imaging device 346 to take a snapshot every time the passageway 314 aligns itself with the light source 342, e.g., thus creating a “hole” or chamber access area in front of the light source 342.

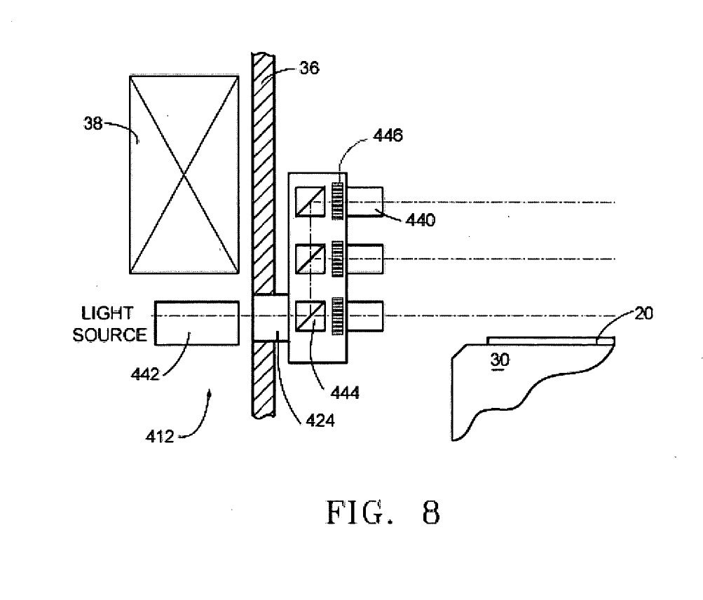

FIG. 8 shows a measurement system 412, which is an alternative embodiment of the measurement system 12. A light source 442 of the measurement system 412 is positioned external the chamber 14, beneath the magnetic field generator 38, to emit light along an optical axis thereof (as shown by a dotted line in FIG. 8) through an optical window or viewport 424. The optical window or viewport 424 can be positioned in the chamber wall 36 and the measurement system 412 can be configured to measure particle concentrations in the chamber 14 through the window or viewport 424.

The measurement system 412 includes a plurality of sheet optic elements 440, each being configured to produce a horizontal light sheet along an optical axis thereof (as shown by a dotted line in FIG. 8). Each sheet optic element 440 is associated with a corresponding beam splitter 444 and a corresponding color filter 446 when the light source 442 is a white light source, for example, a halogen lamp. Light emitted from the light source 442 is split by the beam splitters 444 and provided to the plurality of sheet optic elements 440. Filters 446 are provided in an optical path between a respective beam splitter 444 and a respective sheet optic element 440. The white-light source 442 and the filters 446 allow multi-color illumination of the horizontal light sheets above the substrate or wafer 20, which is positioned in the chamber 14. That way, simultaneous images can be acquired by an imaging device, such as the imaging device 46 shown in FIG. 1. A color separation algorithm, similar to the algorithm described above with respect to FIG. 3, can be implemented by an image processor, for example.

Alternatively, the filters 446 can be used in conjunction with a plurality of different-wavelength lasers or light sources used as the light source 442. In this alternative arrangement, a beam-combiner (not shown) can be used to combine the beams from multiple lasers or light sources into one coincident beam, which can be fed through the window 424. The filters 446 act to pass only one laser wavelength through each sheet optic element 440.

Multi-line lasers, such as an Ar+ ion laser, may also be used. One example of an acceptable Ar+ ion laser is manufactured by Edmund Industrial Optics of Barrington N.J. and sold under the model A54-167 Self-Contained Argon Ion Laser. When a multi-line laser is used, different colored beams of the multi-line laser are already coincident and can be passed directly through the window 424 without the need for a combiner. Filters 446 can be implemented with the multi-line lasers, as needed, to separate colors for multi-color illumination.

In another alternative embodiment, a plurality of shutters (not shown) can replace the color filters 446, in conjunction with a white-light source 442, such as a halogen lamp, or a single color light source, such as a laser. One shutter of the plurality of shutters would remain open during acquirement of the image so that only one light sheet is illuminated at one time. The shutters could be selectively opened or closed during imaging of the multiple light sheets. That way, an imaging device (not shown), such as a black-and-white camera or other imaging device, can be used to image the multiple light sheets at different times. Thus, particle concentration distributions can be measured in the multiple light sheet planes. An image processor, such as the image processor 48, can determine which shutter is selectively opened thereby being capable of imaging and de-projecting the multiple light sheets. For example, the light sheets can be distinguished by the time at which respective images are taken.

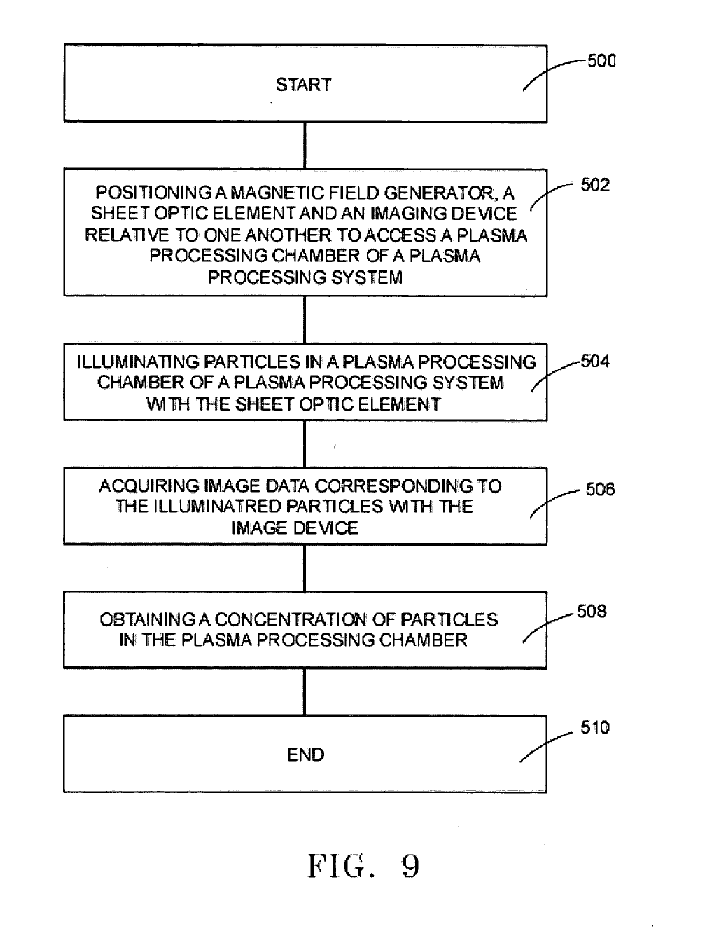

FIG. 9 shows a method in accordance with principles of the invention. The method measures particle concentration in a plasma processing system having a chamber containing a plasma processing region in which a plasma can be generated during a plasma process to process a substrate and a magnetic field generator configured to produce a magnetic field in the chamber.

The method starts at 500. At 502, the magnetic field generator, a sheet optic element and an imaging device are positioned relative to one another to access the plasma in the plasma processing region.

At 504, particles in the chamber are illuminated, for example, by one or more sheet optic elements configured to produce one or more light sheets in the chamber. The one or more light sheets can be produced to be different colors and can be positioned at different angles with respect to the substrate or wafer, for example. Additionally, the one or more light sheets can be rotated around multiple axes in the chamber, for example, around the sheet optics optical axis or an axis perpendicular to the sheet optics optical axis.

At 506, image data corresponding to the illuminated particles is acquired with the imaging device, which can be a camera, CCD or video camera. At 508, a concentration of the particles in the chamber is obtained through processing of the image data in, for example, the image processor. As described above, the image processor may use a combination of hardware or software to perform the processing. At 510, the method ends.

The method can comprise acts, operations or procedures to measure particles in the plasma processing chamber. Various combinations of these additional acts, operations or procedures could be used as well. For example, operations to minimize the particle concentration in the plasma processing system can be added to the above method or used independently with other methods for measuring particle concentration in plasma processing systems.

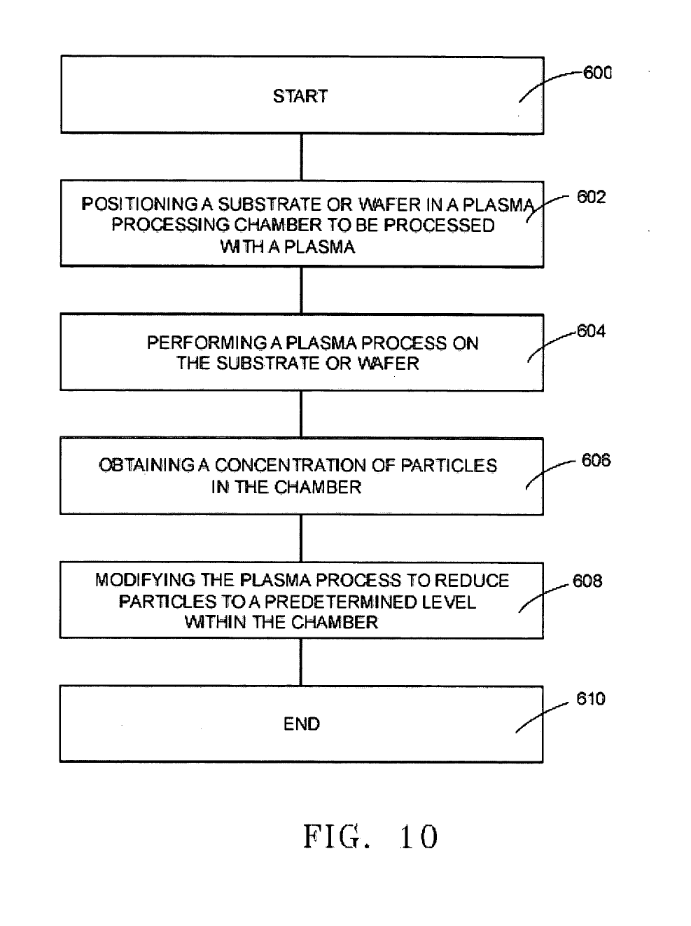

Specifically, FIG. 10 shows a method for minimizing particle concentration in a plasma processing system in accordance with the principles of the invention. The method starts at 600. At 602, a substrate or wafer is positioned in a plasma processing chamber to be processed. At 604, a plasma process is performed on the substrate or wafer. At 606, a concentration of particles in the chamber is obtained, for example, using the above described method shown in FIG. 9. At 608, the plasma process is modified to reduce particles, e.g., removing particles from the chamber with a plasma pump. The optimization method, which is used to minimize particle concentration in the chamber, can be repeated as necessary or the substrate or wafer may be processed if the particle concentration is sufficiently low. At 610, the method ends.

While the present invention has been particularly shown and described with reference to the embodiments described above, it will be understood by those skilled in the art that various changes in form and details can be made therein without departing from the spirit and scope of the invention.

Thus, the foregoing embodiments have been shown and described for the purpose of illustrating the functional and structural principles of this invention and are subject to change without departure from such principles. Therefore, this invention includes all modifications encompassed within the spirit and scope of the following claims.

1. A plasma processing system comprising:
a chamber containing a plasma processing region;
a chuck, configured to support a substrate within the chamber in the processing region;
a plasma generator in communication with the chamber, the plasma generator being configured to generate a plasma during a plasma process in the plasma processing region;
a magnetic field generator configured to produce a magnetic field in the chamber;
a sheet optic element in communication with the chamber, the sheet optic element being configured to produce a light sheet capable of illuminating particles in the chamber;
an imaging device configured to acquire image data corresponding to the particles illuminated by the light sheet,
wherein the magnetic field generator, the sheet optic element and the imaging device are positioned relative to one another to access the plasma; and
an image processor in communication with the imaging device, the image processor being configured to process the image data so as to obtain a concentration of particles in the light sheet.

2. The plasma processing system of claim 1, wherein the sheet optic element includes at least one of a cylindrical lens, a mirror and a prism.

3. The plasma processing system of claim 1, wherein the sheet optic element includes a cylindrical lens and a spherical lens.

4. The plasma processing system of claim 1, further comprising a scanning mirror which cooperates with the sheet optic element to produce the light sheet.

5. The plasma processing system of claim 1, further comprising a light source operatively associated with the sheet optic element.

6. The plasma processing system of claim 1, wherein the imaging device is a camera.

7. The plasma processing system of claim 1, wherein the magnetic field generator is positioned external the chamber and has a substantially annular configuration.

8. The plasma processing system of claim 1, wherein the sheet optic element and the imaging device are positioned above the magnetic field generator.

9. The plasma processing system of claim 8, wherein the sheet optic element is movably mounted to at least one wall of the chamber.

10. The plasma processing system of claim 1, further comprising at least one additional sheet optic element configured to produce at least one additional light sheets capable of illuminating at least one additional plane in the chamber.

11. The plasma processing system of claim 10, wherein the imaging device is configured to acquire image data corresponding to particles in the chamber while the particles are illuminated by the light sheet and the at least one additional light sheet.

12. The plasma processing system of claim 11, wherein the light sheet illuminates the particles with a first light color and the at least one additional light sheet illuminates the particles with a second light color, different from the first light color.

13. The plasma processing system of claim 12, wherein the image processor is configured to distinguish the illuminated particles by the color thereof so that particles illuminated with the first light color can be distinguished from particles illuminated with the second light color.

14. The plasma processing system of claim 10, wherein the sheet optic element and the additional sheet optic element each are at least one of a cylindrical lens, a mirror and a prism.

15. The plasma processing system of claim 10, further comprising a light source operatively associated with the sheet optic element and at least one additional light source operatively associated with the at least one additional sheet optic element.

16. The plasma processing system of claim 15, wherein the light source is a laser having a first wavelength and the additional light source is a laser having a second wavelength.

17. The plasma processing system of claim 15, wherein the light source includes a first color filter and the additional light source includes a second color filter.

18. The plasma processing system of claim 10, wherein at least one of the sheet optic element, the imaging device and the additional sheet optic is fixedly mounted relative to the chamber.

19. The plasma processing system of claim 1, wherein the sheet optic element is movable relative to the chamber such that the sheet optic element is configured to produce the light sheet at multiple planes in the chamber.

20. The plasma processing system of claim 19, wherein the sheet optic element is rotatable about an optical axis thereof to rotate the light sheet through multiple planes in the chamber.

21. The plasma processing system of claim 19, further comprising a drive mechanism coupled to the sheet optic element and configured to move the sheet optic element in a substantially arcuate direction.

22. The plasma processing system of claim 21, wherein the imaging device is synchronized with the drive mechanism such that the imaging device is configured to acquire three-dimensional data corresponding to the particles in the chamber while the particles are illuminated by the light sheet.

23. The plasma processing system of claim 22, wherein the image processor is configured to obtain data relating to the position of the sheet optic element relative to the chamber.

24. The plasma processing system of claim 23, wherein the obtained data includes angular data corresponding to an imaging angle of the sheet optic element relative to the chamber.

25. The plasma processing system of claim 24, wherein the image processor is configured to de-project an image based on at least the angular data.

26. The plasma processing system of claim 21, wherein the arcuate movement of the sheet optic element relative to the chamber rotates the light sheet through multiple planes in the chamber.

27. The plasma processing system of claim 19, further comprising a drive mechanism coupled to the sheet optic element and configured to move the sheet optic element about an optical axis thereof.

28. The plasma processing system of claim 18, wherein the drive mechanism rotates the light sheet through multiple planes in the chamber as the drive mechanism moves the sheet optic element.

29. The plasma processing system of claim 1, wherein the magnetic field generator has a passageway formed therein.

30. The plasma processing system of claim 29, further comprising a light source positioned external to the chamber and configured to emit light through the passageway.

31. The plasma processing system of claim 30, further comprising a shield between the light source and the plasma generator, the shield being configured to reduce light scattered outside the passageway.

32. The plasma processing system of claim 30, wherein the sheet optic element is coupled to the wall of the chamber adjacent to the passageway and is operatively associated with the light source.

33. The plasma processing system of claim 10, further comprising a light source configured to emit light through an optical window positioned between the light source and the light sheet and the at least one additional light sheet.

34. The plasma processing system of claim 33, further comprising at least one beam splitter for each additional sheet optic element, the at least one beam splitter being configured to split the light emitted from the light source after passing through the window into multiple light beams, each of the multiple light beams being provided to separate one of the additional sheet optic elements.

35. The plasma processing system of claim 33, wherein the light source includes at least one multi-line laser.

36. The plasma processing system of claim 33, wherein the light source includes a plurality of lasers, at least two of the lasers having different wavelengths.

37. The plasma processing system of claim 10, further comprising a shutter for the sheet optic element and each additional sheet optic element.

38. The plasma processing system of claim 37, wherein at least one shutter is open to allow light to pass therethrough so that the imaging device can acquire image data on each light sheet, thereby allowing particle concentration distributions to be measured in multiple planes.

39. The plasma processing system of claim 10, wherein the sheet optic lens system further includes at least one filter, the at least one filter being configured to separate the light emitted from the light source into multiple colored light beams, each of the multiple colored light beams being provided to each additional sheet optic element.

40. The plasma processing system of claim 39, wherein each filter separates the light into a respective colored light beam so that different colored light beams are provided to the sheet optic element and each additional sheet optic element.

41. A method of measuring particle concentration in a plasma processing system having a chamber containing a plasma processing region in which a plasma can be generated during a plasma process to process a substrate and a magnetic field generator configured to produce a magnetic field in the chamber, the method comprising:
positioning the magnetic field generator, a sheet optic element and an imaging device relative to one another to access the plasma;
producing a light sheet to illuminate particles in the chamber with the sheet optic element;
acquiring image data corresponding to the illuminated particles with the imaging device; and
obtaining a concentration of particles in the light sheet.

42. The method of claim 41, wherein the magnetic field improves plasma uniformity.

43. The method of claim 41, wherein the light sheet is configured to illuminate particles along at least one vertical or horizontal plane in the chamber.

44. The method of claim 41, wherein the light sheet is configured to illuminate particles in the chamber with one color of light.

45. The method of claim 41, further comprising producing at least one additional light sheet to illuminate particles in the chamber with at least one additional sheet optic element.

46. The method of claim 45, wherein the at least one additional light sheet is configured illuminate particles in the chamber with a different color of light than the light sheet.

47. The method of claim 41, wherein the light sheet is configured to illuminate particles in the chamber through the magnetic field generator.

48. The method of claim 41, wherein the light sheet and the at least one additional light sheet are configured to illuminate particles in the chamber with different colors of light.

49. The method of claim 45, further comprising rotating at least one of the light sheet and the at least one additional light sheet through multiple planes in the chamber.

50. The method of claim 49, wherein the rotating comprises rotating at least one of the light sheet and the at least one additional light sheet about an optical axis thereof through multiple planes in the chamber.

51. The method of claim 49, wherein the rotating comprises circumferentially sweeping at least one of the light sheet and the at least one additional light sheet around the chamber through multiple planes in the chamber.

52. The method of claim 41, wherein the producing includes producing at least one of the light sheet and the at least one additional light sheet parallel to the substrate.

53. The method of claim 49, wherein the light sheet and the at least one additional light sheet are configured to illuminate particles in the chamber with different colors of light.

54. A method of minimizing a particle concentration in a plasma processing chamber of a plasma processing system comprising:
positioning a substrate or wafer in a plasma processing chamber to be processed with a plasma;
performing a plasma process on the substrate or wafer;
obtaining a concentration of particles in the chamber; and
modifying the plasma process to reduce particles to a predetermined level within in the chamber.

55. The method of claim 54, wherein the obtaining comprises:
positioning a magnetic field generator, a sheet optic element and an imaging device relative to one another to access the plasma;
producing a light sheet to illuminate particles in the chamber with the sheet optic element;
acquiring image data corresponding to the illuminated particles with the imaging device; and
obtaining a concentration of particles in the light sheet.

56. The method of claim 54, wherein the modifying includes removing particles from the chamber with a plasma pump.

57. The method of claim 54, further comprising repeating the positioning, the performing, the obtaining and the modifying at least one time.

58. The method of claim 54, further comprising processing the substrate or the wafer.
